(19) United States
(12) Patent Application Publication
(10) Pub. No.: US 2007/0247427 A1
(43) Pub. Date: Oct. 25, 2007

(54) Versatile laser pointer and mouse combination

(76) Inventors: Chaochi Huang, Taipei (TW); Jay Chang, Sijhih City (TW)

Correspondence Address: Raymond Sun, 12420 Woodhall Way, Tustin, CA, 92782, US

(21) Appl. No.: 11/407,817

(22) Filed: Apr. 20, 2006

(51) Int. Cl. G09G 5/08

(52) U.S. Cl. 345/163

(57) ABSTRACT

A versatile laser pointer and mouse combination integrates together the functions of laser pointer and mouse, also preferably includes a presentation program operation function, multimedia player program operation function, and timer to provide users with versatile functions and operation convenience during computer aided presentations, such as lectures, speeches, and the like. Furthermore, the housing and key sets of the versatile laser pointer and mouse combination may be configured to maintain the ergonomics in terms of hand touch of a mouse to be maintained without affecting the convenience of operating all the other added functions.

### BACKGROUND OF THE INVENTION

1. Field Of The Invention

The present invention relates to a versatile laser pointer and mouse combination, and in particular, to a versatile laser pointer and mouse combination which integrates together the functions of laser pointer and mouse, and also preferably includes a controller function for controlling the operation of presentation software and/or multimedia player software and a timer function.

2. Description Of The Related Art

Laser pointers are widely used as teaching or presentation aids. One of the characteristics of a laser beam is that it travels in a coherent beam that only gradually decreases in beam intensity as the beam travels. As a result, teachers or speakers can direct the laser beam emitted from a laser pointer at objects, including those appearing on a screen, for presenting or highlighting desired subject during a lecture or other presentation. Thus, if desired, teachers or speakers can move freely around a lecture or presentation room with little regard for the location of the displayed objects or screen when using a laser pointer.

With recent advancements in technology, making a presentation with the aid of a computer has become very popular. Presenters have been developed to facilitate a speakers use of a laser pointer to guide an audience and concurrently operate a presentation program (such as “Microsoft® Office POWERPOINT®”) installed on a computer. However, currently known presenters do not provide all the functionality that may be desired in a computer aided presentation, such as a lecture or speech. For example, the “Targus Wireless Mini Optical Mouse Presenter” by Targus Europe, Ltd. (Model No. PAWM001E) does not provide a controller function for controlling the operation of multimedia player software (such as “Microsoft® Windows Media Player”) installed on a computer or a timer function. As a result, the Targus presenter does not permit teachers or speakers to control the multimedia player program, thus preventing presentations from being as graphic and vigorous as they potentially could be. Further, the lack of a timer function, prevents the teacher or speaker from accurately controlling the timing of his or her presentation. In the “LOGITECH® Cordless 2.4 GHz Presenter™” by “Logitech Ltd.” there is no mouse function, and thus the user can not operate other programs that may be installed on the computer. The Logitech device also lacks a controller for controlling a multimedia player.

Consequently, a need exists for a versatile laser pointer and mouse combination that also preferably includes a controller function for controlling the operation of presentation software and/or multimedia software and a timer function. Such a device would enable computer aided lectures and presentations to be further improved.

### SUMMARY OF THE INVENTION

An object of the present invention is to provide a new laser pointer and mouse combination. To this end the present invention provides a versatile laser pointer and mouse combination which integrates together the functions of a laser pointer and mouse, and also preferably includes a controller function for controlling the operation of presentation software and/or multimedia software and a timer function to help speakers manage the timing of their presentation. As such, the versatile laser pointer and mouse combination of the present invention is suitable for operating a wide variety of applications on a computer and can be used to emit a laser beam to point at a target.

According to one embodiment, the versatile laser pointer and mouse combination comprises a housing, a first key set, a second key set, a laser module, a mouse module, a display unit, a control unit, and a power module.

The first and second key sets are provided on the housing. The laser module is coupled with the first key set and its operation is responsive to laser pointer operation commands received from the first key set. The mouse module is coupled with the second key set and is adapted to detect mouse commands received from the second key set and then transform the mouse commands into mouse command signals. The control unit is coupled with the mouse module, the display unit, and the first key set. In addition, the control unit is adapted to (i) receive and execute timer operation commands received from the first key set and in turn display timer results on the display unit, (ii) to receive at least one of presentation program operation commands and multimedia player program operation commands from the first key set, and (iii) transform the presentation program operation commands, the multimedia player program operation commands, and the mouse command signals transmitted from the mouse module into electrical signals for output. The power module is adapted to power the laser module, the mouse module, the display unit, and the control unit.

According to another aspect of the invention, a versatile laser pointer and mouse combination, which is suitable for operating a computer and which can emit a laser beam to point at a target, is provided that comprises a housing, a first key set, a second key set, and a circuit module. The housing has first and second exterior surfaces facing in generally opposite directions. The first key set and the second key set are provided on the first exterior surface and the second exterior surface, respectively. The circuit module is provided inside the housing to receive and transform keyboard commands from the first key set and mouse commands from the second key set into electrical signals for operating the computer. The circuit module is also responsive to keyboard commands received from the first key set to turn the laser beam on or off.

In yet a further aspect, a versatile laser pointer and mouse combination is provided comprising a housing, first and second key sets disposed on generally opposite facing surfaces of the housing, and a circuit module disposed inside the housing. The circuit module generates electrical signals for controlling the computer in response to input commands received from the first and second key sets. The circuit module also includes a laser module of a laser pointer that is responsive to input commands received from at least one of the first and second key sets for turning the laser module on and off. Preferably the circuit module further includes a timer that is responsive to input commands received from at least one of the first and second key sets.

The housing and key sets of the various embodiments of the versatile laser pointer and mouse combinations of the present invention may be advantageously configured to allow the tactile ergonomics of a conventional mouse to be maintained without affecting the convenience of operating all the other additional functions. Further, for maximum user freedom, the laser pointer and mouse combinations are preferably wireless.

Further aspects, objects, desirable features, and advantages of the described inventions will be better understood from the detailed description and drawings that follow in which various embodiments of the disclosed inventions are illustrated by way of example. It is to be expressly understood, however, that the drawings and description are for the purpose of illustration only and are not intended as a definition of the limits of the invention.

### BRIEF DESCRIPTION OF THE DRAWINGS

FIG. 1 is a perspective view of a versatile laser pointer and mouse combination according to one preferred embodiment of the present invention.

FIG. 2 is a partial exploded perspective view of the versatile laser pointer and mouse combination in FIG. 1.

FIG. 3 is a plan view of the upper cover of the versatile laser pointer and mouse combination in FIG. 1.

FIG. 4 is a plan view of the lower cover of the versatile laser pointer and mouse combination in FIG. 1.

FIG. 5 is a circuit block diagram of a versatile laser pointer and mouse combination according to one preferred embodiment of the present invention.

### DESCRIPTION OF THE PREFERRED EMBODIMENTS

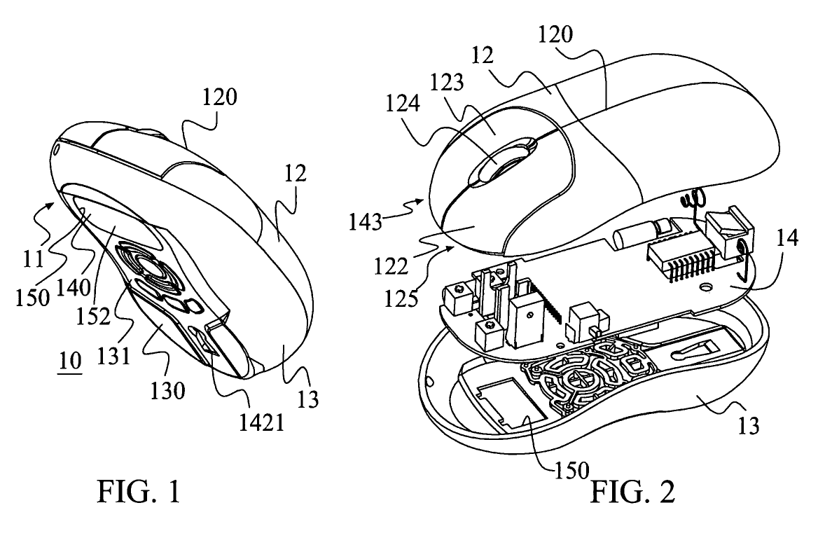

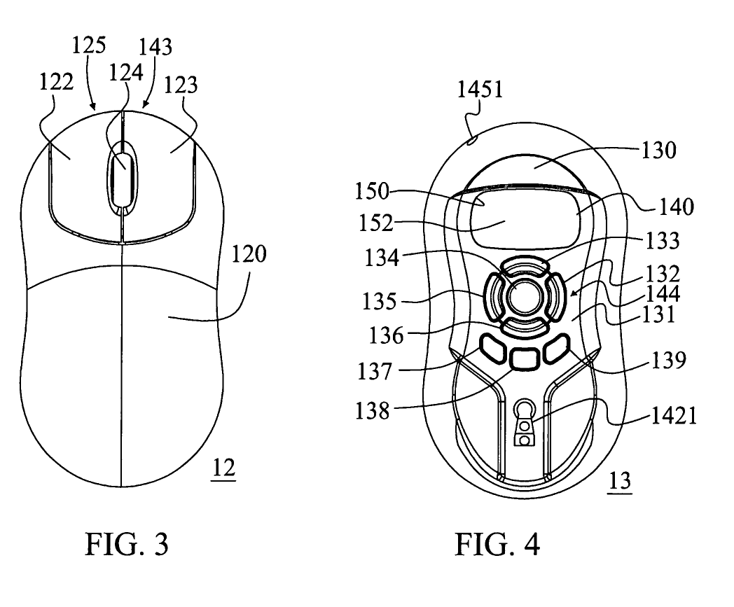

FIGS. 1 to 5 show a versatile laser pointer and mouse combination according to a preferred embodiment of the present invention. In addition to providing the mouse function and being capable of emitting a laser beam as part of the laser pointer function, the versatile laser pointer and mouse combination 10 of the illustrated embodiment is adapted to remotely operate a presentation program and a multimedia player program installed on computer 20 and further has a timer function. Furthermore, the design of the housing 11 of the laser pointer and mouse combination 10 allows the ergonomics in terms of hand touch of a mouse to be maintained without affecting the convenience of operating the various other added functions.

Referring to FIGS. 1 to 5, the housing 11 of the versatile laser pointer and mouse combination 10 comprises an upper cover 12 and a lower cover 13. The upper cover 12 has an exterior surface 120 facing upwards and the lower cover 13 has an exterior surface 130 facing downwards. Thus, as described more fully below, users can turn the housing 11 according to their specific demands or needs while using the versatile laser pointer and mouse combination 10.

With the exception of key sets 143, 144, upper cover 12 and lower cover 13 of housing 11 are each preferably formed from a unitary piece of molded plastic in the present embodiment. In other embodiments, however, the upper cover 12 and/or the lower cover 13 could be formed from a plurality of molded cover portions that form exterior surfaces 120 and 130, respectively, when assembled. Similarly, instead of using upper and lower covers 12, 13 to form housing 11 and exterior surfaces 120, 130, housing 11 may be split in half vertically instead of horizontally to thereby provide mating front and rear covers that would provide surfaces 120, 130 when mated together.

The exterior surface 120 is preferably provided with a protruding curved structure whose front portion 125 is provided with a key set 143. Key set 143 includes a left mouse button 122, a wheel 124 and a right mouse button 123 for inputting mouse commands to operate the computer 20 in a conventional manner. The shape and location of the surface 120, the left mouse button 122, the right mouse button 123, and the wheel 124 are preferably configured to meet ergonomic demands to facilitate the use of the mouse function of the laser pointer and mouse combination 10.

The exterior surface 130 comprises a generally flat surface and a slightly indented operation zone 131, which includes key set 144. In the present embodiment, key set 144 comprises buttons 132, 133, 134, 135, 136, 137, 138, and 139 for inputting laser pointer operation commands, timer operation commands, presentation program operation commands, and multimedia player program operation commands. In other embodiments, key set 143 may include a different arrangement of keys and/or fewer or more keys to input the various commands. Exterior surface 130 further includes a window 150 for mounting the display screen 152 of display unit 140 to display operation results and a light exit window 1421 to allow light generated by the mouse module 142 to exit housing 11. As a result, as best seen from FIG. 4, the display screen 152 is disposed on and forms part of the exterior surface 130. The key set 144 and the recessed operation zone 131 are preferably configured so that key set 144, which includes buttons 132, 133,134, 135, 136, 137, 138, and 139 in the present embodiment, does not extend beyond the generally flat surface of exterior surface 130. Therefore, when the versatile laser pointer and mouse combination 10 is being used as a mouse, the flat surface around the operation zone 131 can be contacted with a table or other flat surface without hindering the operation of the mouse. Furthermore, when the laser pointer function, the timer function, the presentation program operation function, or the multimedia player program operation function of the versatile of the laser pointer and mouse combination 10 are being used, users can hold the versatile laser pointer and mouse combination 10 and maintain the surface 130 facing upwards to facilitate the use of various functions through the manipulation of key set 144.

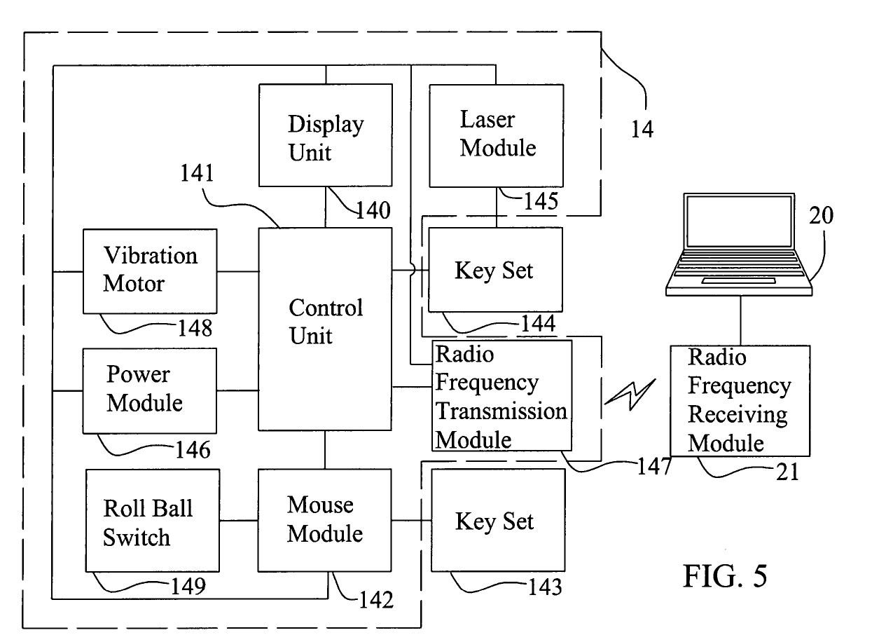

Circuit module 14 provided inside the housing 11 is adapted to receive mouse commands input by pressing one or more of the buttons or wheel of the key set 143. Circuit module 14 is also adapted to receive keyboard or operation commands input by pressing one or more of the buttons of key set 144 for operating a presentation program and/or a multimedia player program running on computer 20. Circuit module 14 transforms the received mouse commands and operation commands into electrical signals for output to computer 20. Circuit module 14 is further adapted to receive laser pointer operation commands input by, for example, pressing the button 134 of key set 144. These keyboard commands selectively turn the laser module 145 on and off. When the laser module 145 is turned on it emits a laser beam through exit window 1451 that may be pointed at a target. The circuit module 14 of the present embodiment is also adapted to receive timer operation commands input by pressing one or more of the buttons of the key set 144 to set and/or start the timer. The operation of the laser pointer and mouse combination 10 will be described in further detail in conjunction with the circuit block diagram for circuit module 14 shown in FIG. 5.

Referring to FIG. 5, the circuit module 14 of the versatile laser pointer and mouse combination 10 of the illustrated embodiment includes a display unit 140, a control unit 141, a mouse module 142, a laser module 145, a power module 146, a radio frequency transmission module 147, a vibration motor 148, and a roll ball switch 149. In other embodiments, the circuit module could include additional or fewer items. For example, if the laser pointer and mouse combination is hardwired to computer 20, radio frequency transmission module 147 could be omitted from circuit module 14. Similarly, in other embodiments, the vibration motor 148, roll ball switch 149, and/or display unit 140 may be omitted.

In circuit module 14 of the present embodiment, the display unit 140 includes a display screen 152, which may, for example, comprise a LCD panel. The control unit 141 may, for example, comprise a microprocessor. The mouse module 142 may, for example, comprise a conventional optical or laser mouse module. The power module 146 may, for example, comprise an ordinary battery set or a rechargeable battery set to provide the power required for the operation of various components of circuit module 14, which are, as best seen in FIG. 5, electrically coupled to the power module 146.

More particularly, in the present embodiment, the laser module 145 is electrically connected with the power module 146 and the button 134 of the key set 144. When a user presses the button 134 to input a laser pointer operation command, current from the power module 146 will flow to the laser diode (not shown) of the laser module 145, such that the laser diode emits a laser beam through exit window 1451 to point at a target, thereby providing a laser pointer function.

In the present embodiment, the mouse module 142 is electrically connected with the control unit 141, the power module 146, and the left mouse button 122, the right mouse button 123, and the wheel 124 of the key set 143. When the mouse module 142 detects the conventional mouse commands, such as a click or double-click on the left mouse button 122, a click or double-click on the right mouse button 123, rotation of the wheel 124, depression of the wheel 124, or movement of the mouse module 142, the mouse commands are transformed into different command signals and transmitted to the control unit 141, which will further transform these command signals into electrical signals for output to computer 20. These electrical signals may be communicated over a cable connected to computer 20, but more preferably a radio frequency transmission module 147 further transforms these electrical signals into radio frequency signals and then broadcasts the radio frequency signals to a radio frequency receiving module 21 attached to the computer 20. Computer 20 then executes the mouse commands.

When the laser pointer, the timer, the presentation program operation function, or the multimedia player program operation function of the versatile laser pointer and mouse combination 10 of the present embodiment are being used, a user can hold the versatile laser pointer and mouse combination 10 with the surface 130 facing upwards to facilitate the operation of the key set 144. In this position, however, the light exit window 1421 of the mouse module 142 will also face up. As a result, the laser beam emitted from the mouse module 142 could potentially hinder the operation of the versatile laser pointer and mouse combination 10 by a user. Thus, the circuit module 14 preferably further comprises a roll ball switch 149 to control the power to the mouse module 142. The roll ball switch 149 is preferably adapted to only turn on the power of the mouse module 142 when the light exit window 1421 faces down and is at an incline of less than 45 degrees. Otherwise, roll ball switch 149 is configured to cut off the power to the mouse module 142, thereby also turning the laser beam of the mouse module 142 off. As a result, the laser beam generated by the mouse module will not hinder a user's operation of the versatile laser pointer and mouse combination 10 of the present embodiment.

Referring to FIGS. 4 and 5, when the laser pointer function, the timer function, the presentation program operation function, or the multimedia player program operation function of the versatile laser pointer and mouse combination 10 of the present embodiment are desired to be used, a user can turn the surface 130 of the versatile laser pointer and mouse combination 10 upward as shown in FIG. 4 and press the button 137 to change the active operation mode of the versatile laser pointer and mouse combination 10. In response to each depression of the button 137, the active operation mode will be changed and shown on the display screen 152 of the display unit 140. Users can then select to press different buttons on the key set 144 according to the active operation mode shown on the display unit 140, and thus to send out the laser pointer operation commands, the timer operation commands, the presentation program operation commands, or the multimedia player program operation commands. The operation commands sent out from users by pressing different buttons will be transformed in the control unit 141 and then transmitted to the computer 20, which will then execute the operation commands.

In the present embodiment, when a user, for example, presses the button 137 to select the mode for operating the presentation program, the user can then press, for example, the button 133 or 136 to turn the pages of their presentation materials (previous or next page), press the button 135 to enter or exit the slide show of their presentation materials, press the button 132 to select to display their presentation materials or not, and continuously press the button 139 and click the button 138 to switch the active window of the computer 20.

Taking the Microsoft® Office POWERPOINT® presentation program as an example, the control unit 141 may be programmed so that when a user presses buttons 133 or 136, the control unit 141 will send out the key codes similar to the key codes generated by the PGUP or PGDOWN keys on the keyboard of the computer 20, thereby allowing a user to turn the page of his or her presentation materials. When a user presses button 135, the control unit 141 may be programmed to alternately send out the key codes similar to the key codes generated by the F5 or ESC keys on the keyboard of the computer 20, to select to enter or exit the slide show of the presentation materials. When a user presses the button 132, the control unit 141 may be programmed to send out the key code similar to the key code generated by pressing down the B button on the keyboard of the computer 20, to select to display the presentation materials or not. When a user continuously presses the button 139 and clicks the button 138, the control unit 141 may be programmed to send out the key code similar to the key code generated by pressing down the ALT+TAB keys on the keyboard of the computer 20 to switch the active window of the computer 20. Of course, as those skilled in the art will appreciate from the instant disclosure, the quantity and form of the presentation program operation commands can be increased, decreased, or changed depending on the demands.

In the present embodiment, when a user presses the button 137 to select the mode for operating the multimedia player program, the user can then, for example, press the button 132 or 135 to play the next or previous music selection, press the button 133 or 136 to increase or decrease the volume, continuously press the button 132 or 135 to conduct fast forward or backward, press the button 138 to play or pause, or press the button 139 to stop playing.

Taking the Microsoft® Windows Media Player multimedia player program as an example, the control unit 141 may be programmed so that when a user presses the button 132 or 135, the control unit 141 will send out the key codes similar to the key codes generated by pressing down the CTRL+F or CTRL+B keys on the keyboard of the computer 20, to play the next or previous music selection. When a user presses the button 133 or 136, the control unit 141 may be programmed to send out the key codes similar to those generated by pressing down the F10 or F9 keys on the keyboard of the computer 20, to increase or decrease volume. When a user continuously presses the button 132 or 135, the control unit 141 may be programmed to send out the key code similar to those generated by pressing down the CTRL+SHIFT+F or CTRL+SHIFT+B keys on the keyboard of the computer 20, to conduct fast forward or backward. When a user presses the button 138, the control unit 141 may be programmed to send out the key code similar to the key code generated by pressing down the CTRL+P keys on the keyboard of the computer 20 to play or pause. When a user presses the button 139, the control unit 141 may be programmed to send out the key code similar to the key code generated by pressing down the CTRL+S keys on the keyboard of the computer 20 to stop playing the selected sound track. Of course, as those skilled in the art will appreciate from the instant disclosure, the quantity and form of the multimedia player program operation commands can be increased, decreased, or changed depending on the demands.

Finally, in the present embodiment, when a user presses the button 137 to select the mode for operating timer function, the user can then, for example, press the button 138 to enter the setting of the time and change the time by using the buttons 132, 133, 135, and 136. A user can then press the button 139 to start the timer's countdown after setting the time. When the countdown is finished, preferably the control unit 141 is programmed to send out a message that the countdown is finished to be displayed on the display unit 140, or actuate the vibration motor 148 to notify users.

From the description above, it will be appreciated by those skilled in the art that the versatile laser pointer and mouse combinations 10 according to the present invention can not only emit a laser beam as part of a laser pointer function for pointing at a target, but also has functions for operating a presentation program and/or multimedia player program running on the computer 20 and a timer function, all with convenient operation. Furthermore, the housing 11 and key sets 143 and 144 of the versatile laser pointer and mouse combination 10 of the present invention may be configured to maintain the ergonomics in terms of hand touch of a conventional mouse without affecting the convenience of operating all the other added functions.

While various embodiments of a versatile laser pointer and mouse combination, its respective components, and operation have been presented in the foregoing disclosure, numerous other modifications, alterations, and alternate embodiments will become immediately apparent to those skilled in the art from the present disclosure for accomplishing the various aspects of the present invention. Thus, it is to be clearly understood that this description is made only by way of example and not as a limitation on the scope of the invention as claimed below.

What is claimed is:

1. A versatile laser pointer and mouse combination suitable for operating a computer and capable of emitting a laser beam to point at a target, the combination comprising:
a housing;
a first key set provided on the housing;
a second key set provided on the housing;
a laser module coupled with the first key set, the operation of the laser module being responsive to laser pointer operation commands received from the first key set;
a mouse module coupled with the second key set, the mouse module adapted to detect mouse commands received from the second key set and then transform the mouse commands into mouse command signals;
a display unit;
a control unit coupled with the mouse module, the display unit, and the first key set, the control unit adapted to (i) receive and execute timer operation commands from the first key set and in turn display timer results on the display unit, (ii) receive at least one of presentation program operation commands and multimedia player program operation commands from the first key set, and (iii) transform the presentation program operation commands, multimedia player program operation commands, and the mouse command signals into electrical signals for output; and
a power module adapted to power the laser module, the mouse module, the display unit, and the control unit.

2. The combination as defined in claim 1 further comprising a radio frequency transmission module to receive the electrical signals output from the control unit and transform the electrical signals into radio frequency signals for transmission to the computer.

3. The combination as defined in claim 1 further comprising a vibration motor, wherein the control unit actuates the vibration motor when the control unit receives an appropriate timer operation command and a pre-selected time has lapsed.

4. The combination as defined in claim 1 further comprising a roll ball switch adapted to control power to the mouse module.

5. The combination as defined in claim 1, wherein the mouse module comprises a laser mouse module.

6. The combination as defined in claim 1, wherein the control unit comprises a microprocessor.

7. The combination as defined in claim 1, wherein the housing comprises a first exterior surface and a second exterior surface, the first and second exterior surfaces face opposite directions, and the first key set and the second key set are provided on the first exterior surface and the second exterior surface, respectively.

8. The combination as defined in claim 7, wherein the first exterior surface comprises a generally flat surface and an indented operation zone, the first key set is disposed in the operation zone, and the first key set and the operation zone are configured so that the first key set doesn't extend beyond the generally flat surface.

9. The combination as defined in claim 7, wherein the second exterior surface comprises a protruding curved surface whose front portion is provided with the second key set.

10. The combination as defined in claim 7, wherein the display unit comprises a display screen that is disposed on the first surface.

11. A versatile laser pointer and mouse combination suitable for operating a computer and capable of emitting a laser beam to point at a target, the combination comprising:
a housing having a first exterior surface and a second exterior surface, the first and second exterior surfaces facing in generally opposite directions;
a first key set provided on the first exterior surface;
a second key set provided on the second exterior surface; and
a circuit module provided inside the housing to receive and transform keyboard commands from the first key set and mouse commands from the second key set into electrical signals for operating the computer, the circuit module also responsive to keyboard commands received from the first key set to turn the laser beam on and off.

12. The combination as defined in claim 11, wherein the first exterior surface comprises a generally flat surface and a recessed operation zone adapted to receive the first key set in a manner that the first key set will not protrude beyond the flat surface.

13. The combination as defined in claim 11, wherein the second exterior surface comprises a protruding curved surface and the second key set is disposed at an front portion of the second exterior surface.

14. The combination as defined in claim 11, wherein the keyboard commands include laser pointer operation commands, timer operation commands, presentation program operation commands, and multimedia player program operation commands, and the circuit module comprises:
a laser module coupled with the first key set, the operation of the laser module being responsive to the laser pointer operation commands;
a mouse module coupled with the second key set, the mouse module adapted to detect the mouse commands and then transform the mouse commands into mouse command signals;
a display unit;
a control unit coupled with the mouse module, the display unit, and the first key set, the control unit adapted to (i) receive and execute the timer operation commands and in turn display timer results on the display unit, and (ii) transform the presentation program operation commands, the multimedia player program operation commands and the mouse command signals into electrical signals for output; and
a power module adapted to power the laser module, the mouse module, the display unit, and the control unit.

15. The combination as defined in claim 14 wherein the circuit module further comprises a radio frequency transmission module to receive the electrical signals output from the control unit and transform the electrical signals into radio frequency signals for transmission to the computer.

16. The combination as defined in claim 14 further comprising a vibration motor, wherein the control unit actuates the vibration motor when the control unit receives an appropriate timer operation command and a pre-selected time has elapsed.

17. The combination as defined in claim 14 further comprising a roll ball switch adapted to control power to the mouse module.

18. The combination as defined in claim 14, wherein the mouse module comprises a laser mouse module.

19. The combination as defined in claim 14, wherein the control unit comprises a microprocessor.

20. The combination as defined in claim 14, wherein the display unit comprises a display screen that is disposed on the first surface.

21. The combination of claim 11, wherein the circuit module includes a radio frequency transmission module that transforms the electrical signals into radio frequency signals for transmission to the computer.

22. A versatile laser pointer and mouse combination comprising:
a housing;
first and second key sets disposed on generally opposite facing surfaces of the housing;
a circuit module disposed inside the housing, the circuit module generating electrical signals for controlling the computer in response to input commands received from the first and second key sets, the circuit module including a laser module of a laser pointer that is responsive to input commands received from at least one of the first and second key sets for turning the laser module on and off.
